(19) United States
(12) Patent Application Publication
(10) Pub. No.: US 2014/0092735 A1
(43) Pub. Date: Apr. 3, 2014

(54) APPARATUS AND METHOD FOR CONTROLLING CONGESTION IN VEHICULAR COMMUNICATION

(71) Applicant: Electronics and Telecommunications Research Institute, Daejeon-si (KR)

(72) Inventors: Sang-Woo LEE, Daejeon-si (KR); Hyun-Seo OH, Daejeon-si (KR); Woo-Yong HAN, Daejeon-si (KR)

(73) Assignee: Electronics and Telecommunications Research Institute, Daejeon-si (KR)

(21) Appl. No.: 13/975,853

(22) Filed: Aug. 26, 2013

(30) Foreign Application Priority Data
Sep. 28, 2012 (KR) 10-2012-0109402

(51) Int. Cl. H04W 28/02

(52) U.S. Cl. CPC H04W 28/0231
USPC 370/230

(57) ABSTRACT

An apparatus and method for controlling congestion in a vehicular communication, capable of preventing the network throughput from being lowered due to increase in the number of vehicles, the method including: determining whether a communication channel is in a congestion condition as a message to be transmitted exists; and if determined as the congestion condition, transmitting a message in a transmission section that is determined within a time frame based on a current position.

### CROSS-REFERENCE TO RELATED APPLICATION

This application claims priority from Korean Patent Application No. 10-2012-0109402, filed on Sep. 28, 2012, in the Korean Intellectual Property Office, the entire disclosure of which is incorporated herein by reference for all purposes.

### BACKGROUND

1. Field

The following description relates to a technology for vehicular communication, and more particularly, to an apparatus and method for controlling congestion occurring in a vehicular communication.

2. Description of the Related Art

As a way to decrease traffic accidents and achieve the efficiency in road management, in the recent years, a vehicle-to-vehicle (V2V) communication and a vehicle-to-infrastructure (V2I) communication have garnered a large amount of interest, and a wireless access in vehicular environments (WAVE) standard has been constituted as an IEEE-based vehicle-to-vehicle communication standard.

In the WAVE standard, an IEEE 802. 11 CSMA/CA scheme of a conventional wireless LAN standard is defined as MAC protocols. According to the vehicle-to-vehicle communication using CSMA/CA, vehicles contend with each other for transmission against each other, and a vehicle having won the contention acquires a wireless channel and starts transmission. A vehicle having lost in the contention increases a contention window thereof, and participates in the contention again.

Meanwhile, due to the characteristics of CSMA/CA scheme, an increase in the number of terminals to transmit frames causes network throughput to increase. The throughput, after exceeding a predetermined level, decreases. This is because, if two or more vehicles transmit frames at the same time, a transmission collision occurs, and the increase in the number of terminals to transmit frames results in an increase in the collisions. Accordingly, if the number of vehicles to transmit frames increases, the frequency of collisions between transmitted messages increases, causing a difficulty in delivering the transmitted messages properly.

The frame transmission in the WAVE MAC protocol is achieved through a unicast or a broadcast scheme. The unicast scheme has a destination for a message to be transmitted, and provides a procedure to retransmit messages in case of transmission failure. However, the broadcast scheme does not have a procedure capable of recognizing the transmission failure, and thus a transmission-failed frame cannot be retransmitted.

Information about a driver's own vehicle (speed or position) may be periodically transmitted by use of the vehicle-to-vehicle communication, and nearby vehicles may use the information for a collision prevention service. For such a service, a basic service message (BSM) format is defined in the United States, and a cooperative awareness message (CAM) is defined in Europe. The messages are periodically generated and broadcasted. Accordingly, as mentioned above, the increase in the number of vehicles results in the increase in the collision frequency of the transmitted messages due to the characteristics of CSMA/CA, and thus the delivery of the transmitted messages is not properly achieved. In addition, as a drawback of the CSMA/CA scheme, a hidden node problem may be issued. Collisions by the hidden node also need to be considered.

Accordingly, in order to support a safety-related service together with a collision prevention service, there is a need for a congestion control capable of avoiding the transmission failure due to the increase in traffic.

### SUMMARY

The following description relates to an apparatus and method for controlling congestion in a vehicular communication, capable of preventing the network throughput from being lowered due to increase in the number of vehicles.

In one general aspect, an apparatus for controlling congestion in a vehicular communication includes a channel monitoring unit, a congestion condition determining unit, a global positioning system receiving unit, a channel configuration management unit, and a channel access control unit. The channel monitoring unit may determine whether a current channel is being used based on a signal being input from an antenna. The congestion condition determining unit may determine whether the current channel is in a congestion condition depending on determination by the channel monitoring unit as to whether the current channel is being used. The global positioning system (GPS) receiving unit may generate current position information by use of a signal being received from a satellite. The channel configuration management unit may generate channel configuration information including transmission section information that is determined within a time frame according to the current position information being output from the GPS receiving unit. The channel access control unit, if determined by the congestion condition determining unit that the current channel is in the congestion condition, may perform control such that a message received from an upper level is transmitted in a transmission section by referring to the channel configuration information being input from the channel configuration management unit.

In another general aspect, a method of controlling congestion in a vehicular communication includes determining whether a communication channel is in a congestion condition as a message to be transmitted exists, and if determined as the congestion condition, transmitting a message in a transmission section that is determined within a time frame based on a current position.

Other features and aspects will be apparent from the following detailed description, the drawings, and the claims.

### BRIEF DESCRIPTION OF THE DRAWINGS

FIG. 1 is a graph illustrating a change in throughput according to a change in the number of terminals.

FIG. 2 is a drawing illustrating a hidden node problem.

FIG. 3 is a drawing illustrating a channel architecture in accordance with an example of the present disclosure.

FIG. 4 is a block diagram illustrating a configuration of an apparatus for controlling congestion in a vehicular communication in accordance with an example of the present disclosure.

FIG. 5 is a flowchart illustrating a method for controlling congestion in a vehicular communication in accordance with an example of the present disclosure.

FIG. 6 is a drawing illustrating a channel allocation in accordance with an example of the present disclosure.

FIG. 7 is a drawing illustrating a solution of a hidden node problem.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

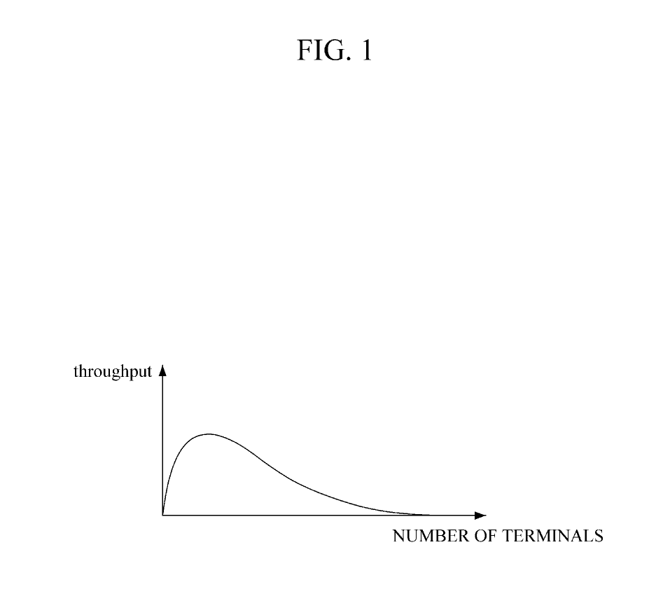

FIG. 1 is a graph illustrating a change in throughput according to a change in the number of terminals.

Referring to FIG. 1, for the WAVE MAC protocol, as the number of terminals to transmit frames increases, the throughput increases, and upon exceeding a predetermined level, the throughput decreases.

This is because as the number of terminals increases, a transmission failure occurs due to a collision between frames of terminals that attempt a wireless access.

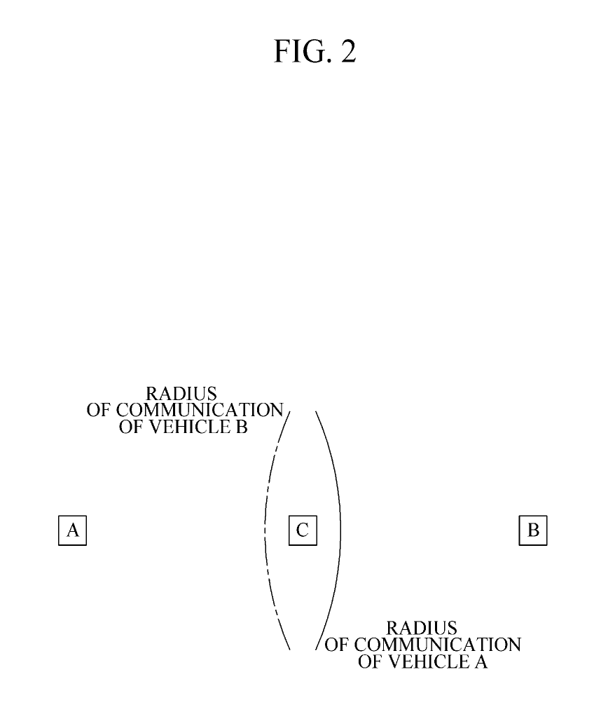

FIG. 2 is a drawing illustrating a hidden node problem.

Referring to FIG. 2, vehicle A, vehicle B and vehicle C may exist. When assumed that a radius of communication of vehicle A is denoted as a solid line and the radius of communication of vehicle B is denoted as a dotted line, if vehicle A transmits a message, vehicle B may be able to receive the message, but vehicle C does not recognize whether vehicle A has transmitted the message. Accordingly, vehicle C may determine that a wireless channel is not being used, and thus transmits a message. At this time, if vehicle A and vehicle C simultaneously transmit messages, the two messages collide with each other, and thus vehicle B fails to receive a message properly.

In order to prevent the throughput from being lowered due to the collision as the above in a vehicle-to-vehicle communication, the present disclosure provides a congestion control function, in which a wireless channel is divided into constant time frames, and a terminal of each vehicle has a transmission section varying with the position thereof with respect to each time frame, so that the number of frames applied to the wireless channel is adjusted.

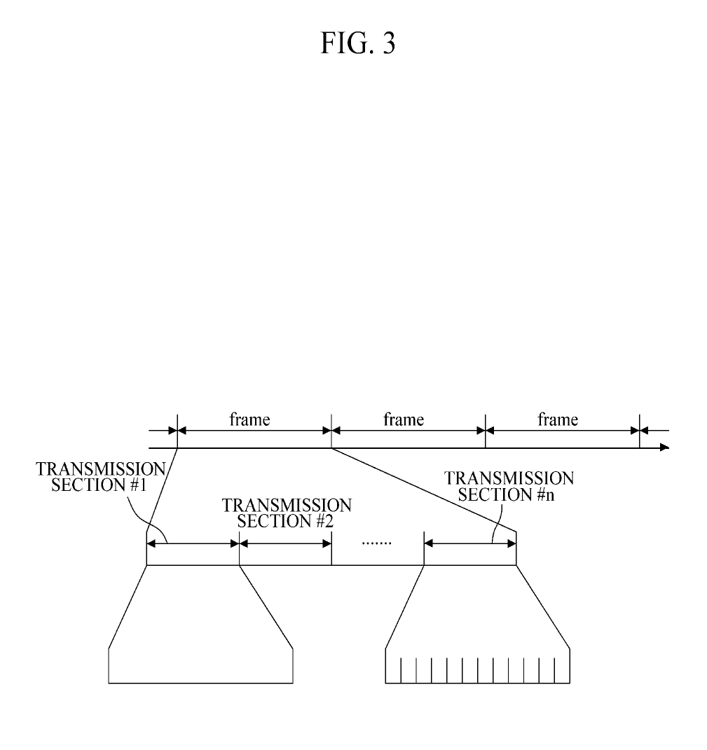

FIG. 3 is a drawing illustrating a channel architecture in accordance with an example of the present disclosure.

Referring to FIG. 3, a channel consists of time frames that are repeated at a constant interval. A single time frame is divided into a plurality of transmission sections. Basically, within a unicast section, a channel access control is achieved in a carrier sense multiple access/collision avoidance (CSMA/CA) scheme. In order to overcome the drawbacks of CSMA/CA scheme described above, a unicast section may be composed of time slots at a constant interval. In a case in which a unicast section is composed of times slots, each time slot is operated in a time division multiple access (TDMA) scheme.

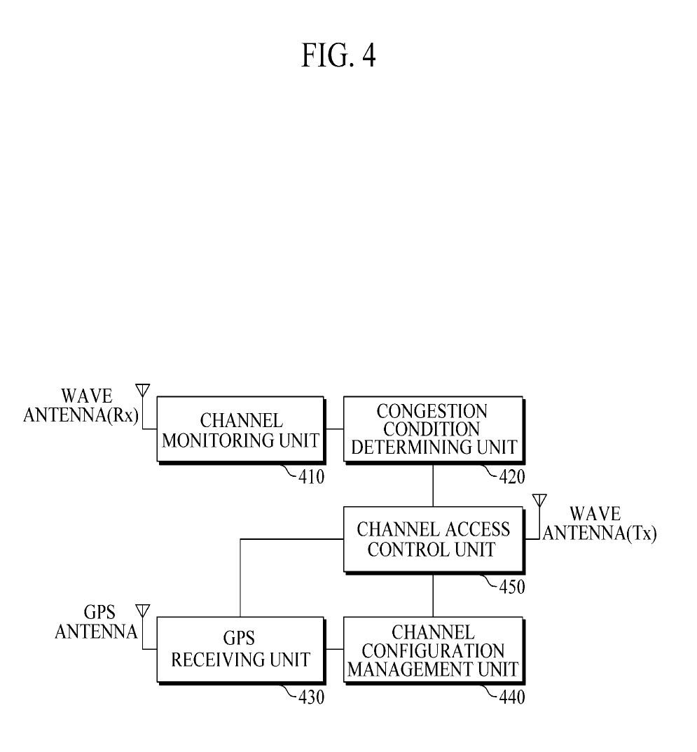

FIG. 4 is a block diagram illustrating a configuration of an apparatus for controlling congestion in a vehicular communication in accordance with an example of the present disclosure.

Referring to FIG. 4, an apparatus for controlling congestion in a vehicular communication includes a channel monitoring unit 410, a congestion condition determining unit 420, a channel access control unit 450, a global positioning system (GPS) receiving unit 430, and a channel configuration management unit 440.

The channel monitoring unit 410 determines whether a current channel is being used by determining a signal being received from a WAVE antenna, and delivers a result of the determination to the congestion condition determining unit 420.

The congestion condition determining unit 420 determines whether the current channel is in a congestion condition based on information being delivered from the channel monitoring unit 410. For example, the congestion condition determining unit 420 may calculate a period of time for which a channel per unit time is occupied, and if the period of time is greater than or equal to a predetermined threshold value, may determine that the current channel is in the congestion condition. An algorithm to determine the channel congestion condition is not a subject matter of the present disclosure, and thus the detailed description thereof will be omitted. In addition, the congestion condition determining unit 420 periodically performs the determination of the congestion condition, and notifies a result of the determination to the channel access control unit 450.

The GPS receiving unit 430 generates current position information and a pulse per second (PPS) signal by use of a GPS signal being input from a satellite, and delivers the current position information and the PPS signal to the channel configuration management unit 440. The PPS signal is generated every second, and the channel configuration management unit 440 forms a channel as shown in FIG. 3 by use of the PPS signal. The channel configuration management unit 440 distinguishes a transmission section available for each node to transmit a message from a transmission section unavailable for each node to transmit a message, and delivers information regarding the transmission sections to the channel access control unit 450.

The length of the time frame and the selection of the transmission section available for transmitting a message are set by use of a predetermined setting value.

The channel access control unit 450 controls a channel access based on information being input from each of the congestion condition determining unit 420 and the channel configuration management unit 440. That is, upon notified by the congestion condition determining unit 420 as being in a congestion condition, the channel access control unit 450 attempts a channel access of a transmission section that is set at the current position according to the channel configuration information being transmitted from the channel configuration management unit 440, thereby transmitting a message delivered from an upper layer. However, in case of being notified by the congestion condition determining unit 420 as being in a non-congestion condition, the channel access control unit 450 attempts a channel access regardless of the channel configuration information, thereby transmitting a message delivered from an upper layer.

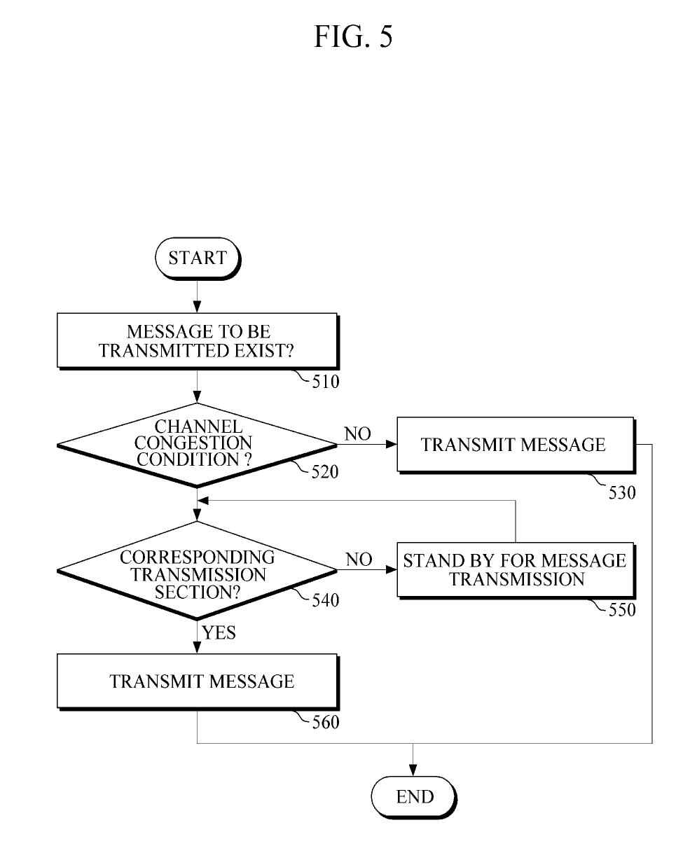

FIG. 5 is a flowchart illustrating a method for controlling congestion in a vehicular communication in accordance with an example of the present disclosure.

Referring to FIG. 5, an apparatus for controlling congestion in a vehicular communication (hereinafter, referred to as a ‘congestion control apparatus’), depending on recognition of existence of a message to be transmitted (510), determines regarding a channel congestion condition (520). According to an example of the present disclosure, the congestion control apparatus determines whether a current channel is being used, by determining a signal being received from a WAVE antenna, calculates a period of time during which a channel per unit time is occupied, and if the period of time is greater than or equal to a predetermined threshold value, determines that the current channel is in the congestion condition.

If determined from operation 520 as being in a non-congestion condition, the congestion control apparatus accesses a channel to transmit a message (530). In this case, the channel access is implemented by the CSMA/CA scheme.

However, if determined from operation 520 as being in the congestion condition, the congestion control apparatus checks a corresponding transmission section that is determined to correspond to a current position within a time frame (540). According to an example of the present disclosure, current position information is acquired by use of a GPS signal being input from a satellite, and it is determined whether a transmission section is available for transmission at the current position. Here, the length of the time frame and the selection of the transmission section available for transmitting a message are set by use of a predetermined setting value.

If determined from operation 540 as a transmission section unavailable for transmission at the current position, the congestion control apparatus stands by for message transmission (550).

However, if determined from operation 540 as a transmission section available for transmission at the current position, that is, in case of a transmission section allocated at the current position, the congestion control apparatus accesses a channel to transmit a message (560).

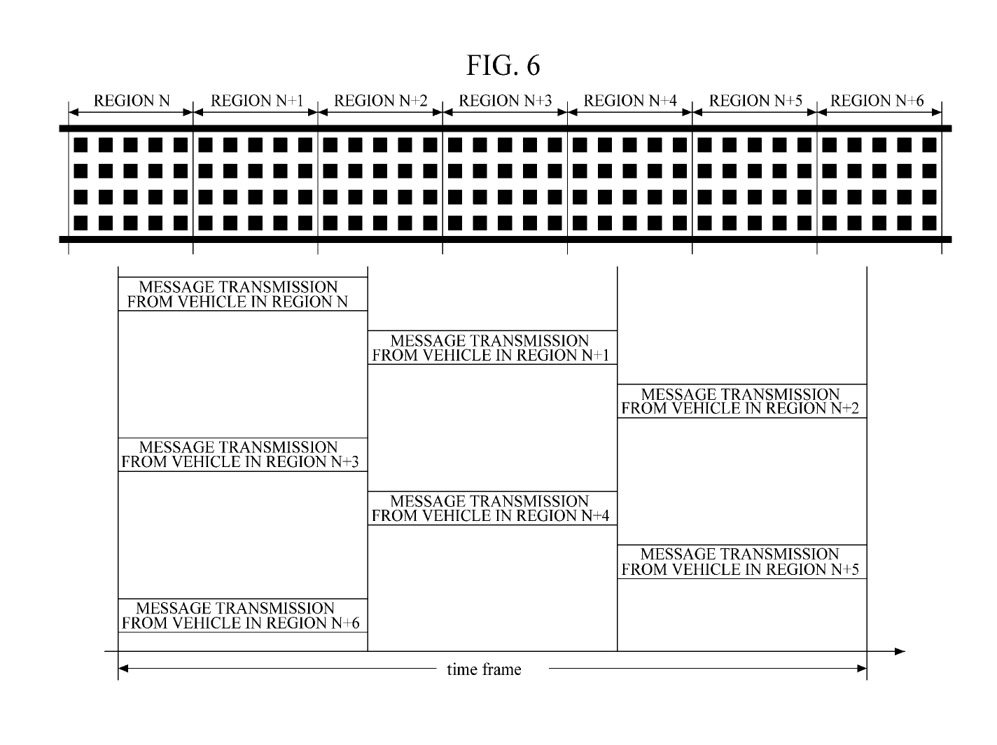

FIG. 6 is a drawing illustrating a channel allocation in accordance with an example of the present disclosure.

Referring to FIG. 6, it may be assumed that vehicles exist on a road, and a single time frame is divided into three transmission sections and operated. That is, a single time frame is divided into a first transmission section, a second transmission section, and a third transmission section, and based on the position of a vehicle, a transmission is performed only at one of three transmission sections. Vehicles existing in region n, region n+3 and region n+6 use the first transmission section, vehicles existing in region n+1 and region n+4 use the second transmission section, and vehicles existing in region n+2 and region n+5 use the third transmission section to transmit messages. However, the channel configuration is illustrated only as an example of the present disclosure, and the channel configuration is embodied in various forms.

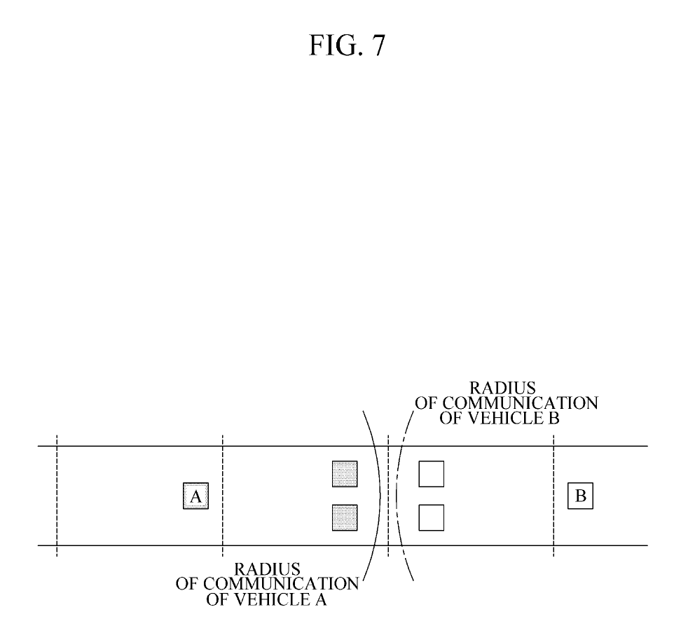

FIG. 7 is a drawing illustrating a solution of a hidden node problem.

Referring to FIG. 7, vehicle A and vehicle B control transmission output such that messages are transmitted using the same transmission section without overlapping radiuses of communication between each other. Accordingly, a hidden node is not generated, so that a message loss due to the hidden node problem is overcome.

As is apparent from the above description, in case of a congestion state, the channel access is remarkably distributed when compared to the conventional technology. Accordingly, the contention probability is decreased, and thus the transmission failure due to contention is also decreased, thereby improving the transmission performance. In addition, the hidden node problem is prevented by adjusting the transmission output and the transmission section.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling congestion in a vehicular communication, the apparatus comprising:
a channel monitoring unit configured to determine whether a current channel is being used based on a signal being input from an antenna;
a congestion condition determining unit configured to determine whether the current channel is in a congestion condition depending on determination by the channel monitoring unit as to whether the current channel is being used;
a global positioning system (GPS) receiving unit configured to generate current position information by use of a signal being received from a satellite;
a channel configuration management unit configured to generate channel configuration information including transmission section information that is determined within a time frame according to the current position information being output from the GPS receiving unit; and
a channel access control unit, if determined by the congestion condition determining unit that the current channel is in the congestion condition, configured to perform control such that a message received from an upper level is transmitted in a transmission section by referring to the channel configuration information being input from the channel configuration management unit.

2. The apparatus of claim 1, wherein the congestion condition determining unit, if an occupancy time of a channel per unit time is greater than or equal to a predetermined threshold value, determines that the current channel is in the congestion condition.

3. The apparatus of claim 1, wherein the congestion condition determining unit periodically determines whether the current channel is in the congestion condition, and transmits a result of the determination to the channel access control unit.

4. The apparatus of claim 1, wherein the channel access control unit, if determined by the congestion condition determination unit that the current channel is not in the congestion condition, performs control such that a message received from an upper level is transmitted regardless of information being transmitted from the channel configuration management unit.

5. The apparatus of claim 1, wherein the channel monitoring unit receives a signal based on a wireless access in vehicular environments (WAVE) standard.

6. The apparatus of claim 1, wherein the channel configuration management unit generates the channel configuration information such that a channel transmission is performed in a transmission section different from a transmission section of a vehicle in a nearby region.

7. A method of controlling congestion in a vehicular communication, the method comprising:
determining whether a communication channel is in a congestion condition as a message to be transmitted exists; and
if determined as the congestion condition, transmitting a message in a transmission section that is determined within a time frame based on a current position.

8. The method of claim 7, wherein the determining of the congestion condition comprises:
determining whether a current channel is being used, based on a signal being input from an antenna; and
determining whether the current channel is in a congestion condition depending on whether the current channel is being used.

9. The method of claim 8, wherein in the determining of the congestion condition, if an occupancy time of a channel per unit time is greater than or equal to a predetermined threshold value, the communication channel is determined to be in the congestion condition.

10. The method of claim 8, wherein the determining of the congestion condition is periodically repeated.

11. The method of claim 7, wherein if determined that the communication channel is not in the congestion condition, a message received from an upper level is controlled to be transmitted.

12. The method of claim 7, wherein a channel configuration is made such that a channel transmission is performed in a transmission section different from a transmission section of a vehicle in a nearby region.
